(19) United States
(12) Patent Application Publication
(10) Pub. No.: US 2004/0141001 A1
(43) Pub. Date: Jul. 22, 2004

(54) Data processing apparatus

(76) Inventor: Patrick Van Der Heyden, St-Bruno (CA)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 10/402,835

(22) Filed: Mar. 28, 2003

(30) Foreign Application Priority Data
Jan. 17, 2003 (GB) 03 01 052.7

(51) Int. Cl. G09G 5/00

(52) U.S. Cl. 345/723

(57) ABSTRACT

Data processing apparatus for use when editing digitised image clips. An image storage device stores digitised image data corresponding to a plurality of image frames displayable at sequential times to form a clip. A manually operable input device allows a user to generate location data defining a first location of a selected region within a first selected one of the image frames, and a second different location of a selected region within a second selected one of the image frames. A processor calculates a location of a calculated region within image frames between the first and the second selected image frames wherein the calculated location of the calculated regions gradually changes from the first location to the second location. Pixel data is selected from within the calculated region of image frames between the first and the second selected image frames to generate new displayable frames of a new clip.

### CROSS-REFERENCE TO RELATED APPLICATIONS

This application claims the benefit under 35 U.S.C. § 119 of the following co-pending and commonly-assigned patent application, which is incorporated by reference herein:

United Kingdom Patent Application Number 03 01 052.7, filed on Jan. 17, 2003, by Patrick Van Der Heyden, entitled “DATA PROCESSING APPARATUS”.

This application is related to the following commonly-assigned patent, which is incorporated by reference herein:

U.S. Pat. No. 6,404,975, filed on Apr. 14, 1997 and issued on Jun. 11, 2002, by Raju C. Bopardikar and Adrian R. Braine, entitled “VIDEO STORAGE”, Attorney's Docket Number 30566.178-US-U1;

### BACKGROUND OF THE INVENTION

1. Field of the Invention

The present invention relates to data processing apparatus for use when editing digitised image clips, and a method of processing a digitised image clip to generate a new clip.

2. Description of the Related Art

In recent years, systems which record, store, and edit high definition television (HDTV) clips have become known. The clips comprise of a plurality of digitised image frames which, when displayed in a time sequential manner, present a moving video image. However, broadcast television systems still make use of other formats such as NTSC and PAL which require different aspect ratios. Consequently, it is known to select a predefined area of a high definition television clip for use in producing a clip of alternative format. Such a selection may, for example, crop off a strip from the left and right edges of the HDTV clip.

### BRIEF SUMMARY OF THE INVENTION

According to an aspect of the present invention, there is provided data processing apparatus for use when editing digitised image clips, comprising: image storage means configured to store digitised image data corresponding to a plurality of image frames displayable at sequential times to form a clip; a manually operable input means configured to allow a user to generate location data defining a first location of a selected region within a first selected one of said image frames, and a second different location of a selected region within a second selected one of said image frames; and processing means configured to: (a) calculate from said location data a location of a calculated region within image frames between said first and said second selected image frames such that the calculated location of said calculated regions gradually changes from said first location to said second location, and (b) select pixel data from within the calculated region of image frames between said first and said second selected image frames to generate new displayable frames of a new clip.

According to a further aspect of the present invention, there is provided data processing apparatus for use when editing digitised image clips, comprising: an image storage device configured to store digitised image data corresponding to a plurality of image frames displayable at sequential times to form a clip; a manually operable input device configured to allow a user to (a) select one of said plurality of image frames, (b) input location data defining a location of a selected region within a selected frame, and (c) input size data defining a size of said selected region; a visual display unit configured to display an image frame selected in response to an input received at said manually operable input device and to display a corresponding selected region; a processor configured to (i) receive location data and size data defining a first selected region within a first selected one of said image frames, and receive location data and size data defining a second different selected region within a second selected one of said image frames, (ii) calculate from said location data and said size data a location and a size of a calculated region within image frames between said first and said second selected image frames such that calculated locations and calculated sizes of said calculated regions gradually changes from said first selected region to said second selected region, and (iii) select pixel data from within said calculated regions for generating new displayable frames of a new clip.

### BRIEF DESCRIPTION OF THE SEVERAL VIEWS OF THE DRAWINGS

FIG. 1 shows a system 100 for editing image data;

FIG. 2 shows computer 101 of system 100;

FIG. 3 shows main memory 207 of computer 101 and its data content;

FIG. 4 shows a graphical user interface 401 generated by the application software 302 being displayed on monitor 102;

FIG. 5 shows the graphical user interface 401 being used to define a further keyframe;

FIG. 6 illustrates the process of generating a new clip 601 from an existing clip 602;

FIG. 7 shows a flow chart outlining the overall operation of the system 100;

FIG. 8 shows a flow chart of the step 707 of responding to user inputs defining a new clip;

FIG. 9 shows a flow chart of the step 708 of generating new frames in response to the user generated data defining the new clip;

FIG. 10 shows a flow chart of the step 901 of calculating co-ordinates of the top left corner and the width of the crop box for each frame;

FIG. 11 shows a flow chart of the step 1002 of calculating values of the currently selected variable, Z, for each frame;

FIG. 12 shows a flow chart of the step 1106 of calculating the value of the currently selected variable for each frame between two key frames;

FIG. 13 shows a graph illustrating an example of the results of step 1106;

FIG. 14 shows a graph illustrating an example of the results of an alternative embodiment;

FIG. 15 shows a flow chart of the step 902 of calculating the co-ordinates of the bottom right corner and the height (where required) of the crop box for each frame of the clip;

FIG. 16 shows the step 905 of adjusting the number of pixels in each new frame.

### WRITTEN DESCRIPTION OF THE BEST MODE FOR CARRYING OUT THE INVENTION

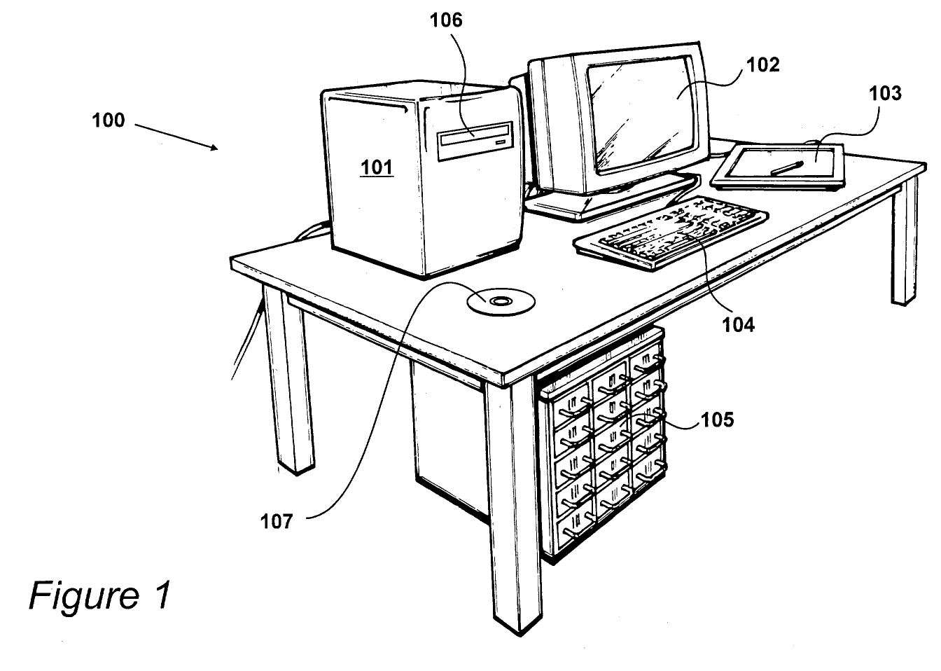

FIG. 1

A system 100 for editing image data is illustrated in FIG. 1. The system includes a computer 101 configured to display video output via a monitor 102. The computer runs applications software that facilitates the editing and image processing operations and monitor 102 provides a graphical user interface to a user, allowing film or video clips to be previewed and edited by the definition of timelines.

The graphical user interface provides the user with several controls and interfaces for controlling the manipulation of image data. The system also includes a graphics tablet 103, to allow the user to interact with the graphical user interface and a keyboard 104 to facilitate alpha numeric input.

The system further comprises a disk based frame storage system 105, referred to herein as a framestore. In preparation for image editing and manipulation, images from one or more film or video input reels are transferred to the framestore 105 via a digital tape player or film scanning apparatus etc.

Framestore 105 may be of the type supplied by the present assignee under the Trademark “STONE” and includes several high capacity hard disk drives arranged to supply and store image data in parallel across many individual drives at once. The drives are configured as a redundant array of independent disks (RAID). Further details of the RAID system are disclosed in U.S. Pat. No. 6,404,975 assigned to Discreet Logic Inc., Quebec, Canada.

From the framestore 105 it is possible to play back and record video images at any location in a clip without having to wait for a tape mechanism to rewind to reach a required frame position, thereby facilitating a process known as non-linear editing.

In this example, computer 101 is a Silicon Graphics Octane and includes a CD ROM drive 106. Application software, providing a graphical user interface and image editing functionality, is installed from a CD ROM 107.

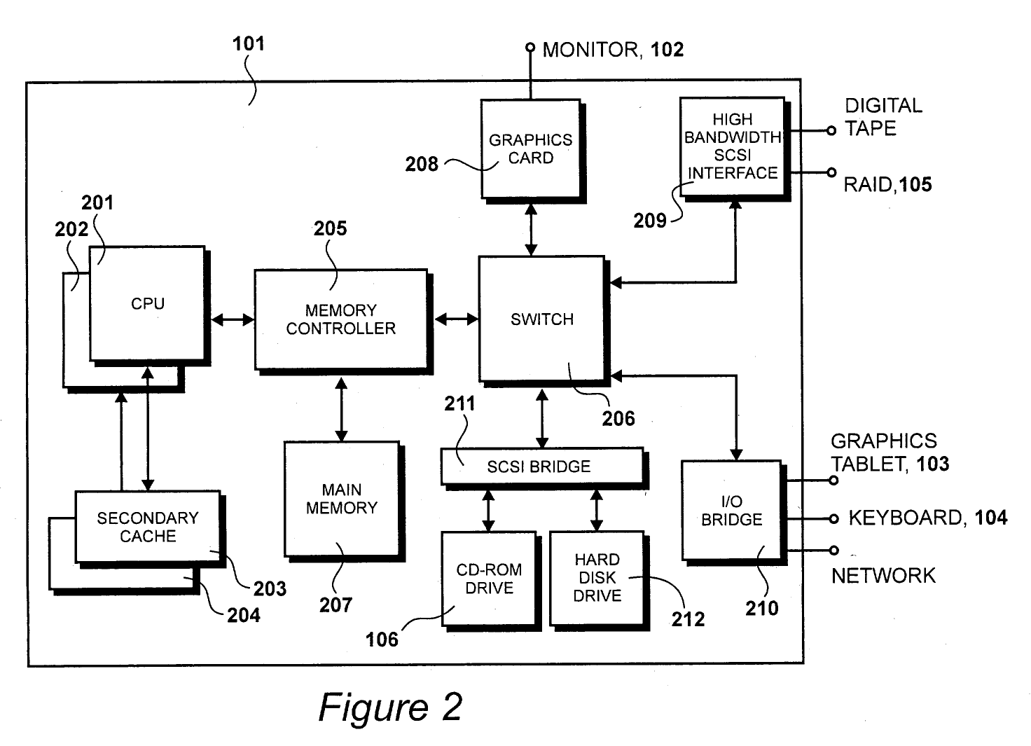

FIG. 2

Computer 100 is illustrated in FIG. 2 and includes two MIPS R12000 central processing units (CPU's) 201 and 202, configured to process instructions and data in parallel. Primary cache facilities are provided within each of processors 201 and 202 and in addition each of processors 201 and 202 are equipped with one megabyte of secondary cache 203 and 204. The CPU's 201 and 202 are connected via a memory controller 205 to a switch 206 and a main memory 207, consisting of two gigabytes of dynamic RAM.

Switch 206 enables up to seven different non-blocking connections to be made between connected circuits. A graphics card 208 receives instructions from CPU 201 or from CPU 202 in order to render image data and graphical user interface components on display monitor 102. A high bandwidth SCSI bridge 209 allows high bandwidth communication to be made with a digital tape player and framestore 105. An input/output bridge 210 provides input/output interface circuitry for peripherals, including the graphics tablet 103, the keyboard 104 and a network. A second SCSI bridge 211 provides interface connections with an internal hard disk drive 212. The second SCSI bridge 211 also provides connections to CD ROM 106, to facilitate the installation of instructions to hard disk 212.

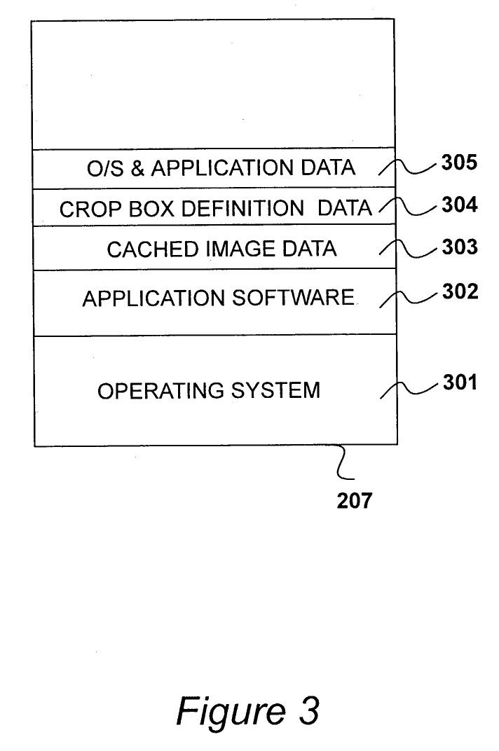

FIG. 3

Main memory 207 and its data content are illustrated in FIG. 3. The main memory 207 provides storage for an operating system 301 along with an application program 302, providing the graphical user interface and facilitating editing operations. In addition, the main memory 207 also provides storage for various data structures including cached image data 303, crop box definition data 304 and other related data 305.

The editing process performed using the application software results in the creation of an new clip made up from the frames of a clip stored on framestore 105, but which comprises only selected regions of the frames of the stored clip. These selected regions are defined by the crop box definition data 304.

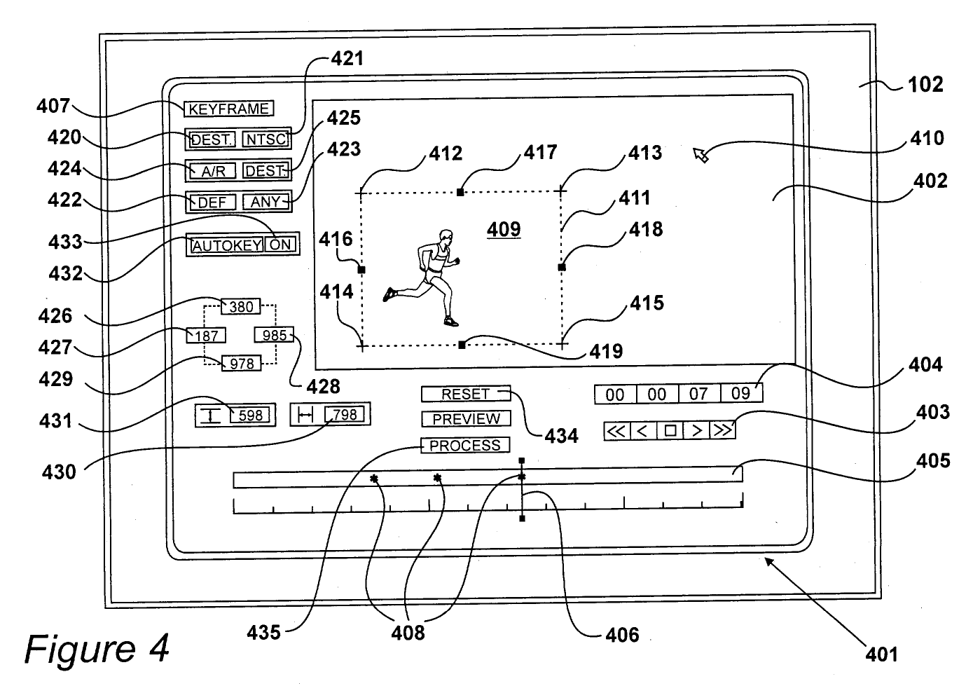

FIG. 4

A graphical user interface 401 generated by the application software 302 is shown displayed on monitor 102 in FIG. 4. The user interface 401 has a video clip display area 402 in which frames of-a video clip stored on framestore 105 may be displayed. A single (still) frame may be displayed in the area 402, or alternatively a sequence of frames may be displayed to provide a moving video image.

The user interface 401 also displays tape control buttons 403, allowing a user to play, stop, reverse, fast-forward or rewind the clip displayed in area 402, and a time code 404 which shows the time location of the frame presently being presented in said area.

A time line 405 representing the clip is also included within the user interface along with a cursor 406 which indicates the location within the clip of the frame presently being displayed in area 402. Thus, if the clip is played, the cursor moves from left to right along the timeline.

The user interface provides the user with tools to generate a new video clip from an existing clip displayed on area 402. The new clip is generated by a process which produces each new frame from image data selected from a region of a frame of the existing clip. The regions that are used to generate the new frames are determined by the user of the system 100, thus allowing creativity and artistry to be provided by the user.

To define which regions of the existing frames are to be selected for use within the frames of the new clip, the user selects the region they require in several frames, referred to as keyframes, spaced throughout the original clip. The application software then analyses the user's selected regions within the keyframes and determines regions for each of the remaining frames in the clip.

The user interface 401, therefore has a keyframe button 407, which when “pressed” indicates to the system 100 that the currently displayed frame is to be a keyframe. The positions of keyframes within the clip are represented by icons 408 displayed on the timeline 405.

Having selected a frame as a keyframe, the user is then able to define a selected region 409, using the graphics tablet 103, or keyboard 104, to manipulate cursor 410. The selected region 409 is bounded by a displayed box 411, referred to as a crop box. The size and location of the region 409 is adjustable by dragging one of the displayed handles 412, 413, 414, 415 located at the corners of the crop box 411, or one of the handles 416, 417, 418 or 419 located on the sides of the crop box.

The new clip may be of the same type as the existing clip, and thus comprise of frames having the same aspect ratio and definition, in terms of number of pixels, as those of the existing clip. Alternatively, the new clip may be of a different type to the existing clip. Thus, for example, the original clip, displayed in area 402, may be a high definition video sequence from which the user uses system 100 to generate a clip of less definition that is suitable for use in an NTSC broadcast. I.e. the system is used to generate frames having a format which corresponds to the destination clip. Alternatively, the generated clip may simply be a sequence of frames of undefined definition and aspect ratio that are to be used in a subsequent compositing process to generate the final destination clip.

In order to allow the user to indicate to the system the video format in which the generated clip is to be used, the user interface has an “DESTINATION” button 420, which when “pressed” provides the user with a list of video types. The selected video type, in this example NTSC, is displayed in an associated window 421.

The user interface also has a button 422 labelled “DEFINITION” which, when pressed, provides the user with a list of options for limiting the size of the selected regions. Thus, for example, the user may choose to: fix the definition, i.e. number of pixels, of the selected regions to the definition of the destination type; limit the definition of the selected regions to be at least that of the destination, in order to ensure good resolution in the final clip; or not limit the size/definition of the selected regions at all. A window 423 provides the user with an indication as to which definition option has been selected. For example, in the case of FIG. 4, the user has selected “ANY” indicating that the size/definition is not limited.

Similarly, the user interface 401 has a button 424 labelled “A/R” which, when pressed, provides the user with a list of options for limiting the aspect ratio of the frames for the generated clip. Thus, the user may choose the aspect ratio of the new frames to be: the same as the existing clip; the same as the destination; or any ratio, as defined by the current aspect ratio of the crop box. A window 425 provides the user with an indication as to which definition option has been selected. For example, in the case of FIG. 4, the user has selected “DEST.” indicating that the aspect ratio is to be limited to that of the destination clip.

As a consequence of the selections made and displayed in windows 421, 423 and 425, the freedom to drag the handles may be limited. For example, in the case shown in FIG. 4, a new clip is being generated for use with NTSC, as is indicated in the window 421 and the aspect ratio of the generated frames is to be that of the destination, i.e. NTSC. Because NTSC requires a specific aspect ratio, the system 100 only allows the handles to be moved such that the crop box 411 has the required aspect ratio. I.e. as the user adjusts a dimension (e.g. width) of the selected region, the system calculates the other dimension (e.g. height) by multiplying (or dividing where appropriate) the first dimension by the aspect ratio.

Similarly, the freedom to drag the handles 412 to 415 and 416 to 419 may be further constrained depending upon which definition option has been selected. For example, if the definition selection, displayed in window 423, limited the definition to be better than the required output, then the crop box could not be reduced in size below a predetermined amount.

Numerical co-ordinates of the edges of the crop box 411 are shown in windows 426, 427, 428, and 429, while values of the width and height of the crop box are shown in windows 430 and 431. The width, height and co-ordinate values for the edges are given in terms of pixels of the frame displayed in area 402. For example, the box 411 has a top left corner which is at a pixel 380 pixels from the top edge of area 402 and 187 pixels from its left edge.

The user interface 401 also includes an “AUTOKEY” button 432 allowing an “Autokey” option to be enabled or disabled. When the “Autokey” function is enabled, as indicated in this example by the word “ON” in window 433, a key is automatically set for the current frame indicating that the frame will be used as a keyframe when the new frames are generated. When the “Autokey” option is not enabled, a key is manually set for the keyframes that are selected for use. A “RESET” button 434 allows said key of a selected keyframe to be reset, and thus the frame will not be used as a keyframe when the new clip is generated.

When the user is satisfied with the selected region 409, they may continue the editing process by selecting a new frame for display in area 402 by, for example, manipulating cursor 406, or by using tape control buttons 403, or alternatively they may terminate the editing process. At such a time, the system 101 automatically stores the co-ordinates, width and height of the crop box 411 for subsequent use when generating the new clip.

The user interface has an “PROCESS” button 435 which is used to indicate that the final selected region of a keyframe has been defined. When the “PROCESS” button is pressed, the processors 201, 202 running under application software 302, process the data defining the selected locations and sizes of the selected regions, such as region 409, to generate the new clip.

It should be understood, that the buttons on Graphical User Interface 401 are merely graphical representations of buttons. Consequently, when the buttons are referred to as being “pressed”, it is meant that they have been selected by manipulation of an input device such as the graphics tablet 103 or the keyboard 104.

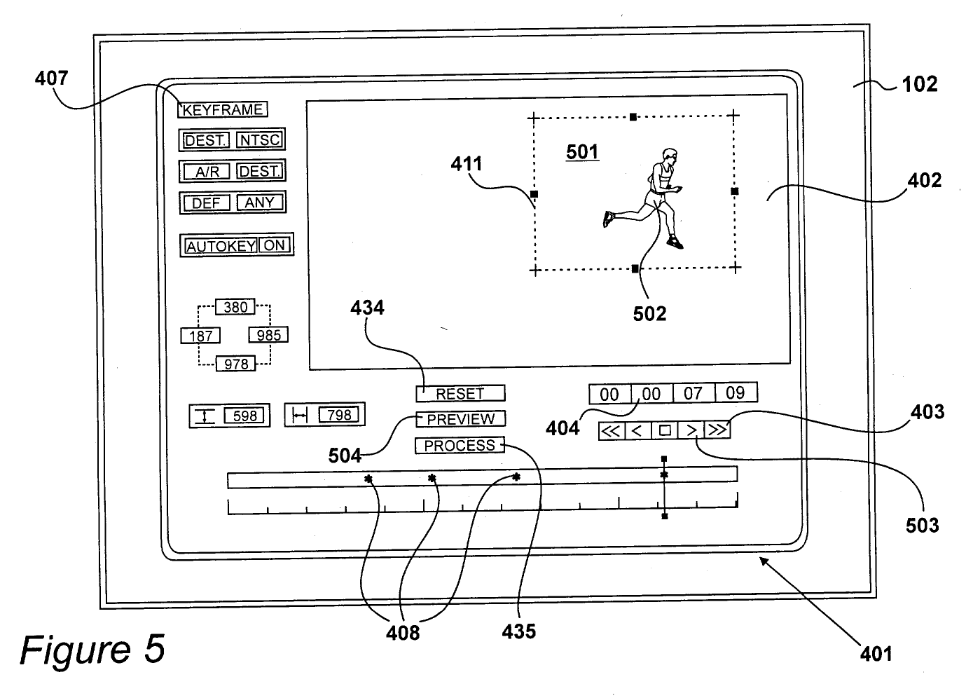

FIG. 5

The graphical user interface 401 is shown in FIG. 5 being used to define another keyframe. A later frame of the existing clip has been selected for display in area 402, and also selected as a keyframe using button 407. The crop box 411 has been repositioned and resized when compared to FIG. 4, and now defines a region 501 of the present keyframe.

The section of the clip between the keyframes of FIG. 4 and FIG. 5 shows a running man 502 whose position within the frames changes with time. The selected regions of FIGS. 4 and 5 have been chosen in order to focus the attention of a human viewer on the man.

When the “PROCESS” button 435 is pressed, the system 100 first calculates the location and size of a region of each frame of the existing clip that is to be used to generate the new frame. The calculated locations and sizes of these calculated regions are such that they gradually change between the locations and sizes defined by the keyframes.

This calculation is also performed if the play button 503 is pressed after keyframes have been defined. Consequently, on depression of the play button 503 the existing clip is played in the area 402, and the crop box 411 is superimposed over the clip, thus showing the region of each frame that is going to be selected for use in the new clip. Since the region gradually changes in location and size between the values defined for the keyframes, the crop box 411 appears to be animated.

Playing the existing clip thus provides the user with an indication of how the new clip will appear. However, alternatively, the user may preview the new clip by pressing the user interface's preview button 504. If the preview button is pressed the system performs similar processing to that performed when the “PROCESS” button is pressed to generate the new clip. However, as the new frames are generated, they are displayed in area 402, or a suitable portion thereof, at video rate, rather than being saved to framestore 105.

Alternatively, the user may select an option in which the area 402 is split during the preview process, allowing the user to compare the source clip and the new clip. Thus, while the newly generated frames are displayed for preview in one portion of area 402, the corresponding frames of the source video clip are displayed simultaneously in another portion.

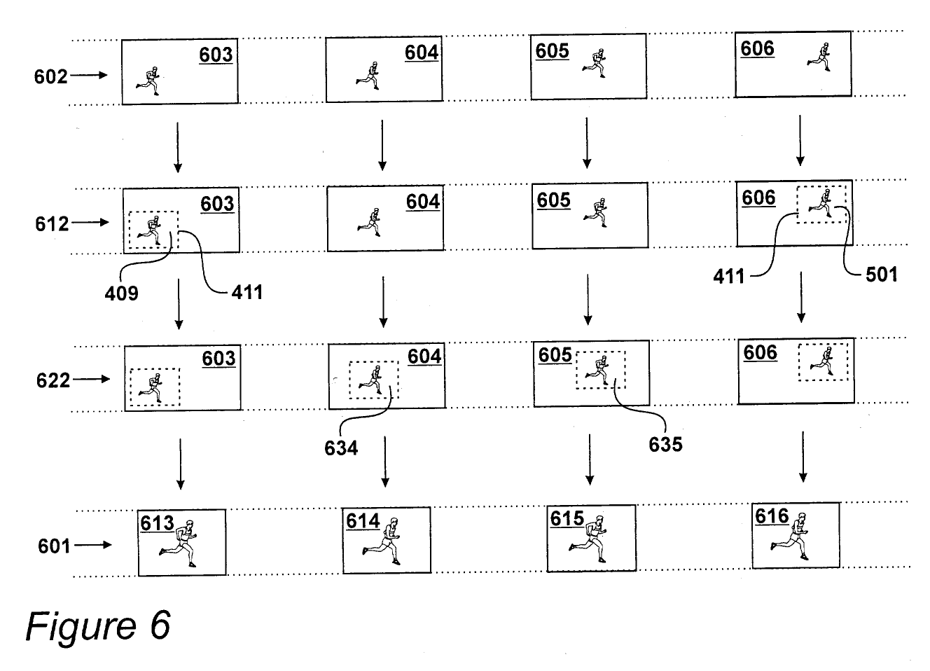

FIG. 6

The process of generating a new clip 601 from an existing clip 602 is illustrated in FIG. 6. Frames 603, 604, 605 and 606 appear in that order in existing clip 602, but these may be separated from each other by a plurality of frames. The four frames 603, 604, 605 and 606 therefore represent a section of the clip which may last several seconds. As described in reference to FIGS. 4 and 5, the new clip is generated by producing a new frame from a region of each of the existing frames. To determine which regions are to be used, a user first selects keyframes and defines which region of the keyframes are to be used. The existing clip is shown at 612 with frames 603 and 606 selected as keyframes, with the crop box 411 indicating the respective user defined regions 409 and 501. Thus, for the purposes of this example, the keyframes 603 and 606 are those shown selected in FIGS. 4 and 5 respectively.

Having selected the keyframes and regions of keyframes to be used in the new clip, the user presses the “PROCESS” button 435, and in response to the depression of the “PROCESS” button the system calculates the location and size of regions to be used in the remaining frames of the clip. The existing clip is illustrated at 622 showing the calculated regions 634 and 635 of frames 604 and 605 which appear between keyframes 603 and 606 in the clip.

Having performed this calculation, the pixel data of the user defined regions, and the calculated regions, of each frame is used to generate a new frame of the required format. Thus, pixel data from user defined regions 409 and 501 is used to generate new frames 613 and 616 respectively, while pixel data from calculated regions 634 and 635 is used to generate new frames 614 and 615 respectively.

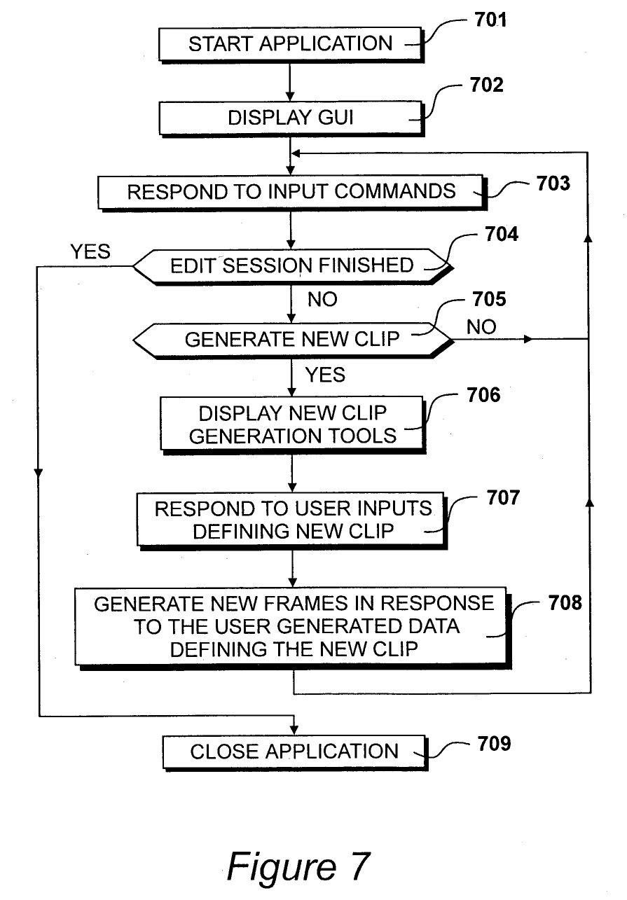

FIG. 7

Flow charts illustrating the operation of the system 100 are shown in FIGS. 7 to 12, 15 and 16. The first of these, shown in FIG. 7, is a flow chart outlining the overall operation of the system. After the application software is started at step 701, a graphical user interface is displayed on monitor 102 at step 702. The system then responds to input commands generated by the manual operation of input devices 103 and 104 at step 703. Thus, at this step a user may select a particular clip on framestore 105 which is to be edited, or from which a new clip is to be generated. Other editing functions may also be performed during this step.

At step 704 a question is asked to determine if a user input has indicated that the editing session should be terminated. If this is answered yes then the application is closed at step 709. Alternatively, a question is asked at step 705 as to whether a new clip is to be generated and if the answer is no, then the process returns to step 703. If the question of step 705 is answered yes, then tools for generating a new clip are displayed at step 706, and user generated data defining the new clip are received and responded to at step 707. After having received the user generated data defining the new clip, the new clip is generated in compliance with said data at step 708. The process then returns to step 703 where editing of the new clip may take place.

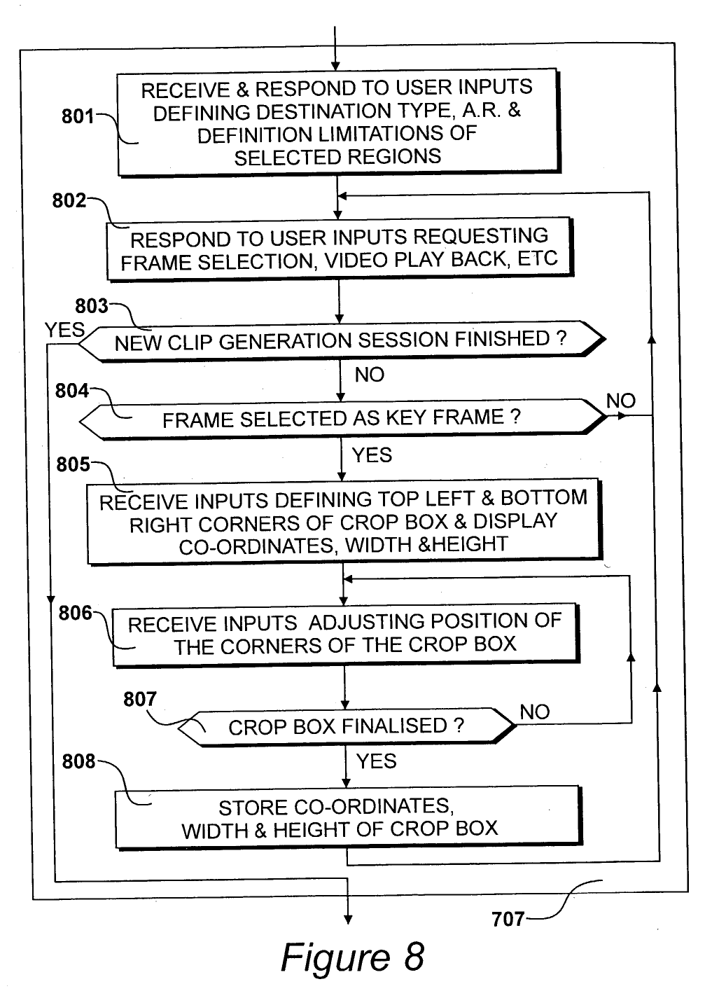

FIG. 8

The step 707 of responding to user inputs defining a new clip is shown in greater detail in the flow chart of FIG. 8. Initially, at step 801, user generated inputs are received defining: the format of the destination clip, i.e. the type of clip within which the generated clip is to be used; and limitations, or otherwise, on the definition and aspect ratio of the selected regions. These selections are displayed in windows 421, 423 and 425. At step 802 the system responds to user generated inputs requesting, for example, a specific frame to be displayed in area 402, requesting the clip to be played back in area 402, requesting fast-forward etc. At step 803 a question is asked to determine whether the user has pressed the “PROCESS” button 435 to end the clip generation session. If this question is answered yes then step 707 is ended, and if it is answered no then step 804 is entered.

At step 804, a question is asked as to whether the presently displayed frame has been selected as a keyframe, by the depression of button 407. If the frame has not been selected as a keyframe then the process returns to step 802. Otherwise user generated inputs are received at step 805 defining co-ordinates for the top left and bottom right corners of the crop box 411. As described earlier, co-ordinates and width and height of the crop box are displayed during this process. At step 806, user generated inputs, corresponding to the dragging of the crop box handles 412 to 415, are received to adjust the position of the crop box. At step 807 it is determined whether the crop box has been finalised, for example, by the user changing the frame displayed in display area 402, and if not, then step 806 is repeated. If the crop box has been finalised then the co-ordinates of the top left and bottom right corners, and the height and width of the crop box are stored at step 808. The process then returns to step 802.

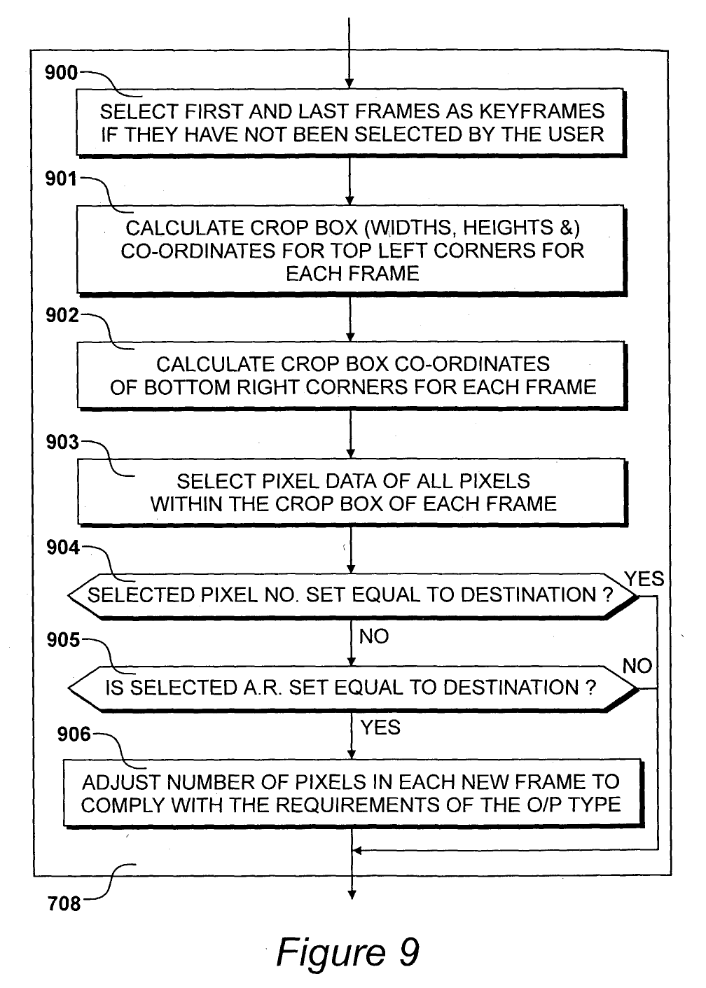

FIG. 9

The step 708 of generating new frames in response to the user generated data defining the new clip, is shown in greater detail in FIG. 9. At step 900 it is determined whether the first or last frame of the clip have been selected by the user as a keyframe. If the first frame has not been selected then it is automatically selected, and the co-ordinates of the selected region for the first frame are made equal to those of the selected region of the first user selected keyframe. Similarly, if the last frame of the clip has not been selected by the user then it is automatically selected, and the co-ordinates of the selected region for the last frame are made equal to those of the last user selected keyframe.

In an alternative embodiment the system may require the user to select the first and last frames as keyframes, or, alternatively, generate a new clip which only has frames generated from the first to the last user defined keyframes.

At step 901, the co-ordinates of the top left corner of the crop box for each frame of the clip are calculated. If the size/definition of the selected regions has not been fixed at step 801, the width and height of the crop box for each frame is also calculated at step 901. At step 902 the co-ordinates of the bottom right corner of the crop box for each frame of the clip are calculated.

Having calculated the first and second pairs of co-ordinates of the crop box at steps 901 and 902 respectively, pixel data representing all of the pixels within the crop box of each frame is then selected at step 903. Thus the crop box defines a region within each of the existing frames from which pixel data is selected to produce a new frame for the new clip.

At step 904 a question is asked as to whether the selected number of pixels was set at step 801 to be the same number as required by the destination clip. If the answer to this question is yes then step 708 is completed. Alternatively step 905 is entered, where it is determined whether or not the aspect ratio selected at step 801 was that of the destination clip. If not then step 708 is completed. This would be the case where the frames are to be used in a subsequent compositing process. Alternatively, if the selected aspect ratio is that of the destination clip then step 906 is entered.

Typically, the number of pixels selected at step 903 will be either too many or too few for the frame size which is to be produced. Consequently, the number of pixels in each new frame is adjusted, at step 906, to comply with requirements of the destination type.

On completion of step 906, step 708 is completed and the process returns to step 703.

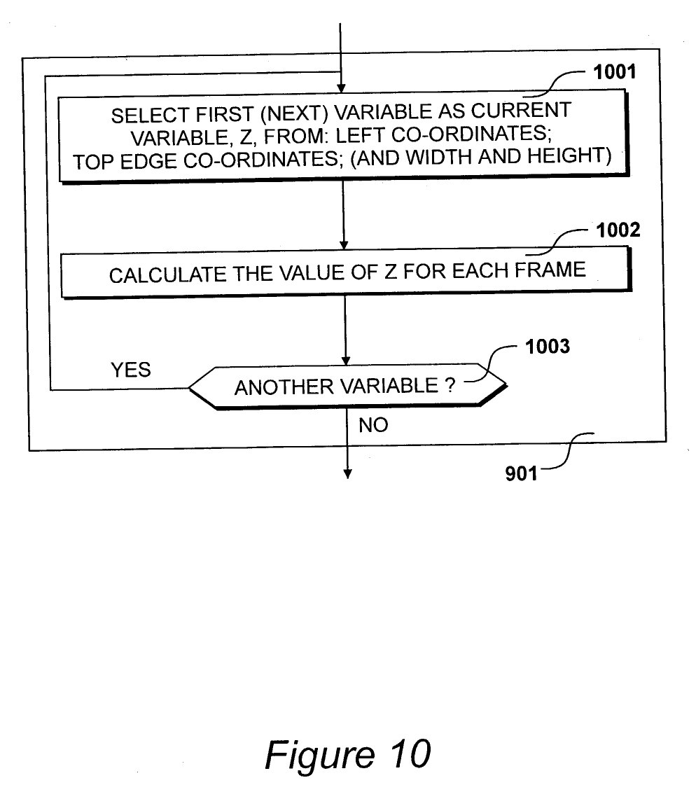

FIG. 10

The step 901 of calculating co-ordinates of the top left corner and the width and height of the crop box for each frame is shown in further detail in FIG. 10. During step 901, at least the co-ordinates of the top left corner are calculated, and in instances where the width and height of the crop box are not fixed at step 801, they are also calculated.

Each of the two co-ordinates, the height and the width, may be considered to be variables whose value varies with increasing frame number. The value of the variables is fixed for particular frames, i.e. the keyframes, but values of each variable must be calculated for the remaining frames such that the value gradually changes between keyframes.

Initially at step 1001 of step 901, the first of the two, or four, variables (left co-ordinates, top edge co-ordinates, and, possibly, height and width) is selected as the current variable, Z. Then at step 1002, the value of the current variable Z is calculated for each frame of the clip. At step 1003 it is determined whether another variable is to be calculated, and if so, the process returns to step 1001 where the next variable is selected and then step 1002 is repeated. Otherwise, if it is determined at step 1003 that all variable values have been calculated then step 901 is completed.

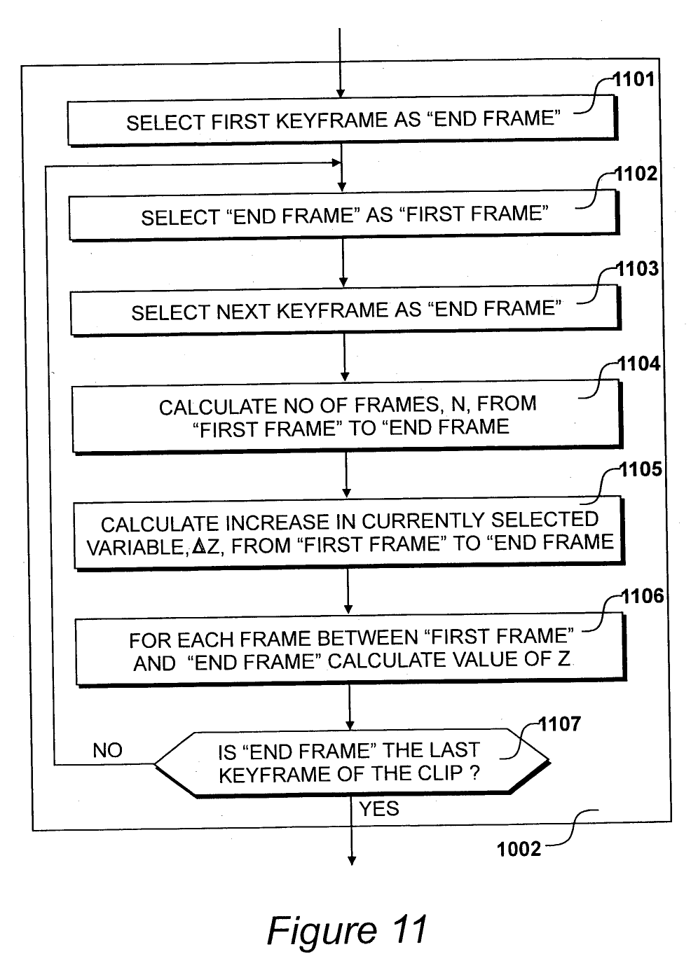

FIG. 11

The step 1002 of calculating values of the currently selected variable, Z, for each frame is shown in detail in FIG. 11. Firstly, at step 1101, the first keyframe appearing in the clip is selected as the “End Frame”. Then the frame currently selected as the “End Frame” is selected as the “First Frame” at step 1102 before the next keyframe of the clip is selected as the “End Frame”. Thus, after step 1101, and the first iteration of steps 1102 and 1103 the “First Frame” is the first keyframe of the clip and the “End Frame” is the second keyframe of the clip.

At step 1104, the number of frames, N, from “First Frame” to “End Frame” is calculated, and the increase in value of the currently selected variable, [symbol] Z, from “First Frame” to “End Frame” is calculated at step 1105. Of course the value [symbol] Z may be negative when the value of the current variable, Z, decreases from “First Frame” to “End Frame”.

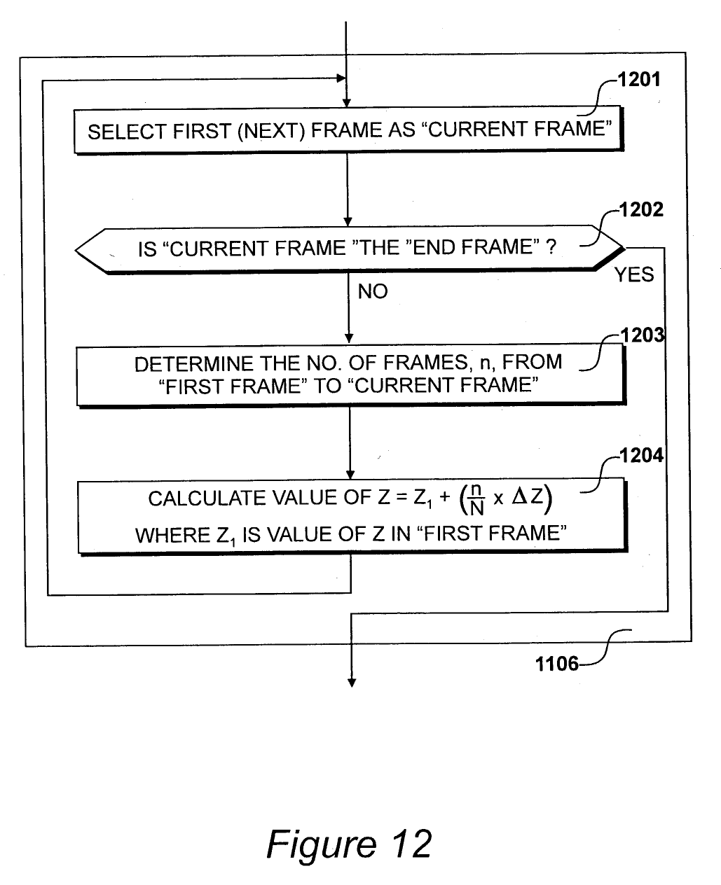

The value of the currently selected variable, Z, is then calculated for each frame between the “First Frame” and “End Frame” at step 1106. This process is described more fully below in respect of FIG. 12.

At step 1107 it is determined whether or not the “End Frame” is the last keyframe of the clip. If it is not then steps 1102 to 1107 are repeated, but if it is, then step 1002 is completed. Thus the process loops around steps 1102 to 1107 until the value of the currently selected variable has been determined for each frame of the clip.

FIG. 12

The step 1106 of calculating the value of the currently selected variable for each frame between two keyframes is shown in FIG. 12. At step 1201 the next frame, starting from the “First Frame”, is selected as the “Current Frame”. Then at step 1202 a question is asked as to whether the “Current Frame” is the “End Frame”, and if so then step 1106 is completed. Otherwise step 1203 is entered, in which the number of frames, n, from the “First Frame” to the “Current Frame” is determined. Then at step 1204 the value of the currently selected variable, Z, for the “Current Frame” is calculated. The calculation involves multiplying [symbol] Z by the result of n divided by N, and then adding this product to the value of Z at the “First Frame”. Thus, in the present embodiment, the process calculates values of the variables, (co-ordinates, height and width) which change linearly over the frames between consecutive keyframes.

After step 1204, the process returns to step 1201 where the next frame in the clip is selected as the “Current Frame”.

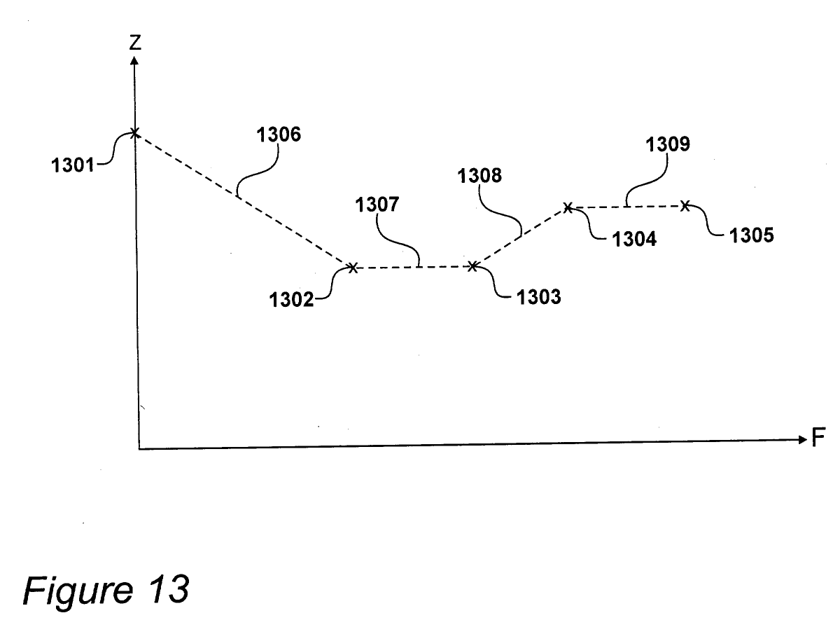

FIG. 13

A graph illustrating an example of the results of step 1106 is shown in FIG. 13. The number of frames, F, from the first frame of the existing clip is plotted along the horizontal axis, and the value of a variable, Z, is plotted along the vertical axis. Z may represent a co-ordinate of the crop box, its height or its width.

Each of five keyframes is indicated by one of five plotted crosses 1301, 1302, 1303, 1304 and 1305, and the calculated values of Z for each frame between the keyframes is shown by the straight lines 1306, 1307, 1308 and 1309. Thus, the linear change of Z between keyframes is illustrated by the straight lines 1306 to 1309.

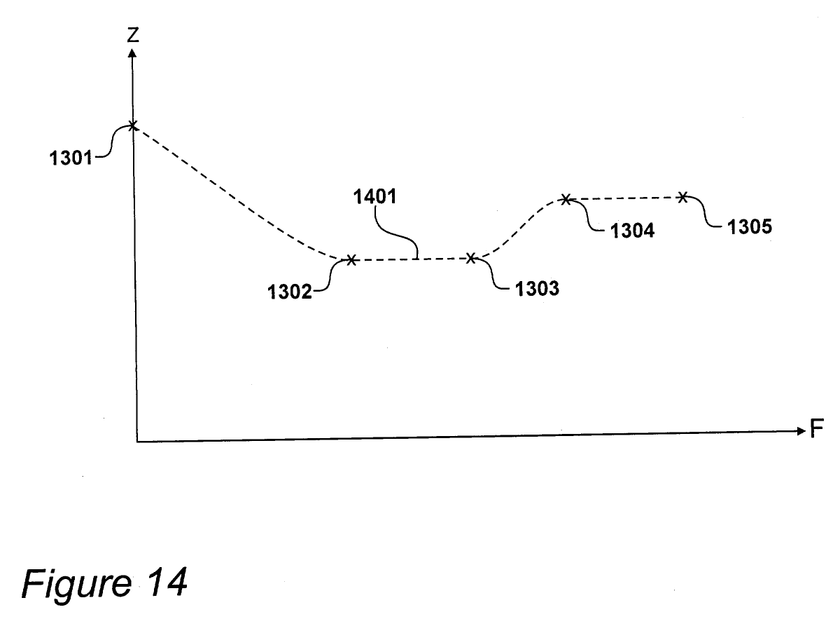

FIG. 14

A graph illustrating an example of the results of an alternative embodiment are shown in FIG. 14. In the alternative embodiment, the process 1002 for calculating the value of Z for each frame is replaced with an alternative step. Whereas step 1002 produces values of Z which change linearly between keyframes, the alternative step generates Z values such that the rate of change of Z value changes smoothly even for frames which are close to keyframes. Consequently, for the same clip and keyframes 1301 to 1305 the straight line segments of FIG. 13 are replaced by a smooth spline curve 1401 as shown in FIG. 14. The alternative system which employs spline curves has the advantage of avoiding apparent abrupt changes in panning or framing in the new clip.

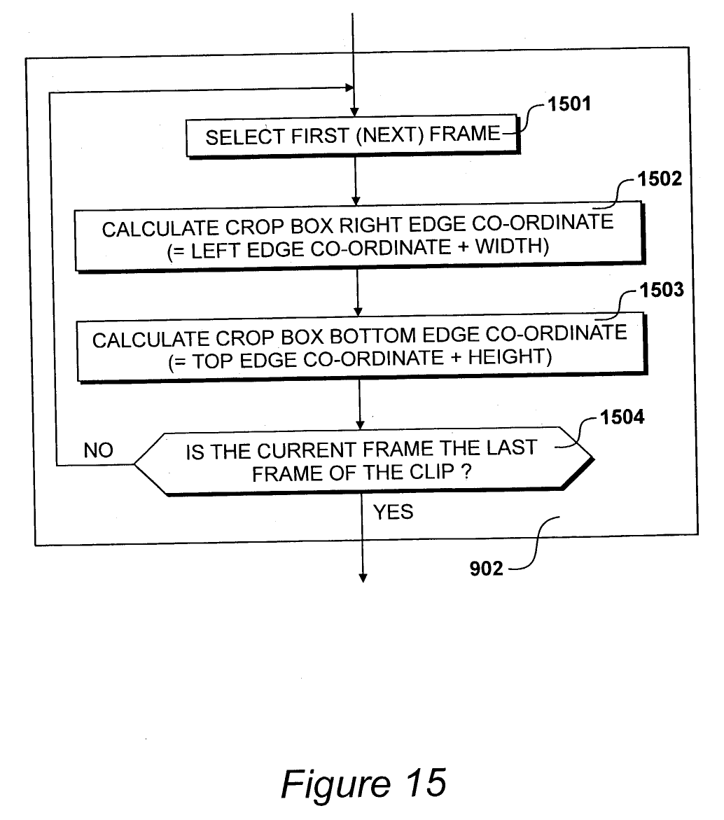

FIG. 15

The step 902 of calculating the co-ordinates of the bottom right corner of the crop box for each frame of the clip is shown in detail in FIG. 15. Firstly, at step 1501, the first frame of the clip is selected.

At step 1502 the crop box right edge co-ordinate is calculated by adding the width to the left edge co-ordinate, found at step 901. Similarly at step 1503 the bottom edge co-ordinate is calculated by adding the height of the crop box to the top edge co-ordinate. At step 1504 a question is asked to determine whether the currently selected frame is the last frame of the clip, and if so then step 902 is completed. Otherwise the process returns to step 1501 where the next frame in the clip is selected and steps 1502 to 1504 are repeated. The process thus loops around step 1501 to 1504 until the second pair of co-ordinates of each crop box has been determined.

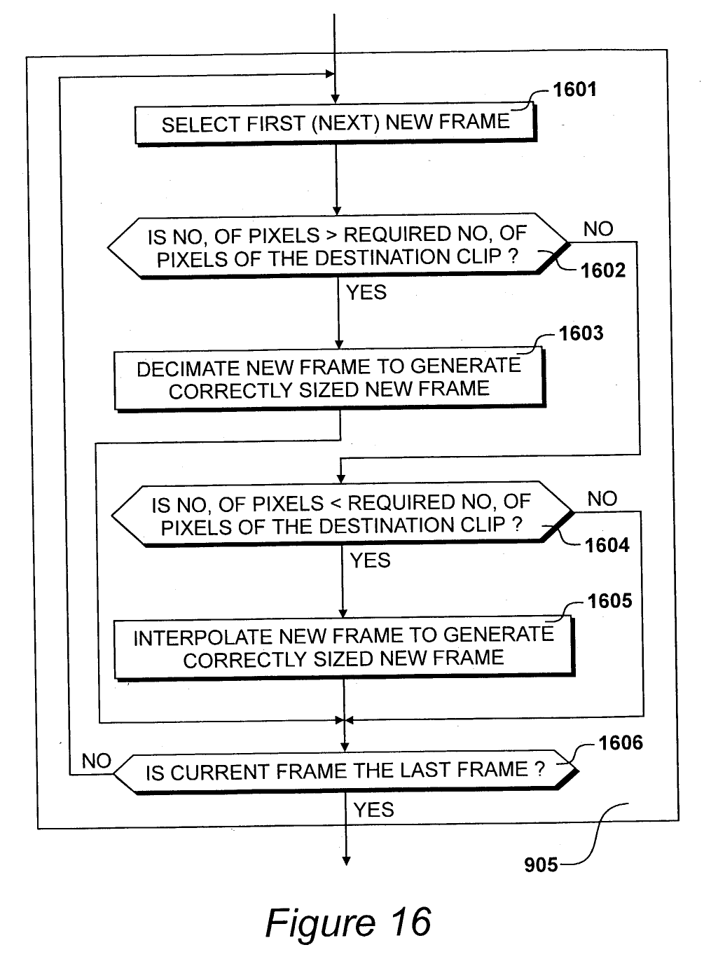

FIG. 16

The step 905 of adjusting the number of pixels in each new frame is shown in detail in FIG. 16. On first entering step 905, at step 1601 the first new frame is selected. At step 1602 it is determined whether the number of pixels in the currently selected frame is greater than the number required for the destination clip. If it is, then the frame is decimated at step 1603 such that that pixels are removed from the frame to generate a correctly sized frame. The process then enters step 1606.

Alternatively, if the question asked at step 1602 determines that the number of pixels is not too great then a question is asked at step 1604 as to whether the number of pixels in the current selected frame are less than the amount required for the destination clip. If the answer is no then step 1606 is entered directly. Otherwise, step 1605 is performed in which new pixels are added to the new frame by an interpolation process, in order to generate a correctly sized new frame. Step 1606 is then entered in which it is determined if the current frame is the last frame of the clip. If it is, then step 905 is completed. Otherwise the process returns to step 1601 where the next new frame is selected. Thus, the process loops around steps 1601 to 1606 until the number of pixels in each new frame has been either increased or decreased to have the correct required number.

On completion of step 905, step 708 is also completed. Thus, on completion of step 905 all of the new frames of the new clip are complete.

In conclusion, using the system 100, in the simplest case, in which a user selects the aspect ratio and definition of selected regions to be that of the destination clip, the user is then merely able to define locations of selected regions within selected frames (keyframes) of an existing clip. The system then processes the location data to calculate the locations of similar such regions in frames between the keyframes, such that the locations of the calculated regions gradually changes between the locations defined for the keyframes. Then pixel data is selected representing the image within each selected or calculated region to generate new displayable image frames.

In cases where the definition of the selected regions is not fixed, at the same time as selecting the locations of selected regions within selected frames (keyframes), the user inputs data defining the size of the selected regions. Using the inputted size data, the system then calculates sizes of the regions for each frame between the keyframes, such that the size of the calculated regions changes gradually between the keyframes.

1. Data processing apparatus for use when editing digitised image clips, comprising:
image storage means configured to store digitised image data corresponding to a plurality of image frames displayable at sequential times to form a clip;
a manually operable input means configured to allow a user to generate location data defining a first location of a selected region within a first selected one of said image frames, and a second different location of a selected region within a second selected one of said image frames; and
processing means configured to:
(a) calculate from said location data a location of a calculated region within image frames between said first and said second selected image frames such that the calculated location of said calculated regions gradually changes from said first location to said second location, and
(b) select pixel data from within the calculated region of image frames between said first and said second selected image frames to generate new displayable frames of a new clip.

2. Data processing apparatus according to claim 1, wherein said manually operable input means is further configured to allow a user to input size data defining a size of the selected region within said first selected image frame, and a second different size of the selected region within said second selected image frame, and said processing means is further configured to calculate from said size data a size of the calculated regions within the image frames between said first and said second selected image frames such that the calculated size of said calculated regions gradually changes from said first size to said second size.

3. Data processing apparatus according to claim 1, wherein said image frames each have a fixed number of pixels, and said new displayable frames have a different number of pixels.

4. Data processing apparatus according to claim 1, wherein said image frames each have a first aspect ratio, and said new displayable frames have a different second aspect ratio.

5. Data processing apparatus according to claim 2, wherein the rate of change of the calculated size of said regions is constant between said first and said second selected image frames.

6. Data processing apparatus according to claim 2, wherein the new displayable frames have a fixed aspect ratio, said manually operable input means is configured to allow a user to input dimensions of a selected region, a first dimension of a selected region representing the size of said region, and said processing means calculates a second dimension from said first dimension and said fixed aspect ratio, whereby displayed images of the new displayable frames are kept in correct proportion.

7. Data processing apparatus according to claim 1, wherein the rate of change of the calculated location of said regions is constant between said first and said second selected image frames.

8. Data processing apparatus according to claim 1, wherein said new displayable frames comprise a fixed number of pixels, and said processing means is configured to compare the number of pixels represented by the pixel data selected from within the calculated region of an image frame with said fixed number of pixels, and depending upon said comparison, to add additional pixel data to the selected pixel data to generate one of said new displayable frames.

9. Data processing apparatus according to claim 8, wherein said image frames from which regions are selected comprise a fixed number of pixels, and said new displayable frames have the same fixed number of pixels.

10. Data processing apparatus according to claim 1, wherein said new displayable frames comprise a fixed number of pixels, and said processing means is configured to compare the number of pixels represented by the pixel data selected from within the calculated region of an image frame with said fixed number of pixels, and depending upon said comparison, to remove pixel data from the selected pixel data to generate one of said new displayable frames.

11. Data processing apparatus according to claim 1, wherein said apparatus includes a display means configured to display (a) said first selected one of said image frames, and (b) a box which is locatable within said first image frame in response to received data from said manually operable input means and used to define said first location of said selected region.

12. Data processing apparatus according to claim 2, further comprising a display means configured to display (a) said first selected one of said image frames, and (b) a box within said first image frame, wherein said box is relocated and resized in response to received data from said manually operable input means and said box is used to define said first location of said first selected region and said size of said selected region.

13. Data processing apparatus according to claim 12, wherein said display means is configured to display a box within said image frames between said first and said second selected image frames, such that said box has a location and size corresponding to said calculated regions, whereby said apparatus shows the region of each frame that is selected for use in the new clip.

14. Data processing apparatus according to claim 1, comprising a display means configured to display said plurality of frames at sequential times as a clip, and to display said new displayable frames at sequential times to provide a preview of a newly generated clip.

15. A method of processing a digitised image clip to generate a new clip, comprising the steps of:
storing digitised image data corresponding to a plurality of frames displayable at sequential times to form an output sequence;
receiving user generated position data defining a selected region at a first location within a first selected one of said frames, and a selected region at a second different location within a second selected one of said frames;
calculating from said location data a location of a calculated region within image frames between said first and said second selected image frames such that the calculated location of said calculated regions gradually changes from said first location to said second location; and
selecting pixel data from within the calculated region of image frames between said first and second selected frames to generate new displayable frames for a new clip.

16. A method of processing a digitised image clip to generate a new clip according to claim 15, including the steps of:
receiving user generated input size data defining a size of the selected region within said first selected image frame, and a second different size of the selected region within said second selected image frame,
calculating from said size data a size of the calculated region within image frames between said first and said second selected image frames such that the calculated size of said calculated regions gradually changes from said first size to said second size.

17. A method of processing a digitised image clip to generate a new clip according to claim 16, wherein the new displayable frames have a fixed aspect ratio, and said method comprises the steps of:
receiving user generated data defining a first dimension of a selected region representing the size of said region, and
calculating a second dimension from said first dimension and said fixed aspect ratio, whereby displayed images of the new displayable frames are kept in correct proportion.

18. A method of processing a digitised image clip to generate a new clip according to claim 15, wherein said new displayable frames comprise a fixed number of pixels, and said method comprises the steps of:
comparing the number of pixels represented by the pixel data selected from within the calculated region of an image frame with said fixed number of pixels; and
depending upon said comparison, adding additional pixel data to the selected pixel data to generate one of said new displayable frames.

19. A method of processing a digitised image clip to generate a new clip according to claim 15, wherein said new displayable frames comprise a fixed number of pixels, and said method comprises the steps of:
comparing the number of pixels represented by the pixel data selected from within the calculated region of an image frame with said fixed number of pixels; and
depending upon said comparison, removing pixel data from the selected pixel data to generate one of said new displayable frames.

20. A computer-readable medium having computer-readable instructions executable by a computer such that, when executing said instructions, a computer will perform the steps of:
storing digitised image data corresponding to a plurality of frames displayable at sequential times to form an output sequence;
receiving user generated position data defining a selected region at a first location within a first selected one of said frames, and a selected region at a second different location within a second selected one of said frames;
calculating from said location data a location of a region within image frames between said first and said second selected image frames such that the calculated location of said regions gradually changes from said first location to said second location; and
selecting pixel data from within the calculated region of image frames between said first and second selected frames to generate new displayable frames for a new clip.

21. A computer-readable medium having computer-readable instructions according to claim 20, such that, when executing said instructions, a computer will perform the steps of:
receiving user generated input size data defining a size of the selected region within said first selected image frame, and a second different size of the selected region within said second selected image frame,
calculating from said size data a size of the calculated region within image frames between said first and said second selected image frames such that the calculated size of said calculated regions gradually changes from said first size to said second size.

22. Data processing apparatus for use when editing digitised image clips, comprising:
an image storage device configured to store digitised image data corresponding to a plurality of image frames displayable at sequential times to form a clip;
a manually operable input device configured to allow a user to
(a) select one of said plurality of image frames,
(b) input location data defining a location of a selected region within a selected frame, and
(c) input size data defining a size of said selected region;
a visual display unit configured to display an image frame selected in response to an input received at said manually operable input device and to display a corresponding selected region;
a processor configured to
(i) receive location data and size data defining a first selected region within a first selected one of said image frames, and receive location data and size data defining a second different selected region within a second selected one of said image frames,
(ii) calculate from said location data and said size data a location and a size of a calculated region within image frames between said first and said second selected image frames such that calculated locations and calculated sizes of said calculated regions gradually changes from said first selected region to said second selected region, and
(iii) select pixel data from within said calculated regions for generating new displayable frames of a new clip.

23. Data processing apparatus according to claim 22, wherein said image frames each have a first aspect ratio, and said new displayable frames have a different second aspect ratio.

24. Data processing apparatus according to claim 22, wherein the rate of change of the calculated location of said calculated regions is constant between said first and said second selected image frames.

25. Data processing apparatus according to claim 22, wherein said visual display unit is configured to display (a) said first selected one of said image frames, and (b) a box within said first image frame representing said first selected region.

26. Data processing apparatus according to claim 22, wherein said display means is configured to display a box within said image frames between said first and said second selected image frames, such that said box has a location and size corresponding to said calculated regions, whereby said apparatus indicates the region of each frame that is selected for use in the new clip.

27. Data processing apparatus according to claim 22, wherein said visual display unit is configured to display said plurality of frames at sequential times as a clip, and to display said new displayable frames at sequential times to provide a preview of a newly generated clip.

28. Data processing apparatus for use when editing digitised image clips, comprising:
an image storage device configured to store digitised image data corresponding to a plurality of image frames displayable at sequential times to form a clip;
a manually operable input device configured to allow a user to generate size data defining a first size of a selected region within a first selected one of said image frames, and a second different size of a selected region within a second selected one of said image frames; and
processing means configured to:
(a) calculate from said size data a size of a calculated region within image frames between said first and said second selected image frames such that the calculated size of said calculated regions gradually changes from said first size to said second size; and
(b) for image frames between said first and said second selected image frames, select pixel data from within the calculated regions for generating new displayable frames of a new clip.
